(19) United States
(12) Patent Application Publication
(10) Pub. No.: US 2013/0307936 A1
(43) Pub. Date: Nov. 21, 2013

(54) METHOD OF FINDING POINT CORRESPONDENCES, DEVICE FOR PERFORMING THE METHOD, AND SYSTEM INCLUDING THE DEVICE

(71) Applicant: SAMSUNG ELECTRONICS CO., LTD., Suwon-si (KR)

(72) Inventor: DONG HOON KIM, Hwaseong-si (KR)

(73) Assignee: SAMSUNG ELECTRONICS CO., LTD., Suwon-si (KR)

(21) Appl. No.: 13/795,336

(22) Filed: Mar. 12, 2013

(30) Foreign Application Priority Data
May 15, 2012 (KR) 10-2012-0051697

(51) Int. Cl. G06K 9/62; H04N 13/02

(52) U.S. Cl. CPC G06K 9/6201; H04N 13/0239
USPC 348/47; 382/201; 382/154

(57) ABSTRACT

A method of finding point correspondences includes dividing a first left image into first sub regions and a first right image into second sub regions, detecting first feature points according to first threshold values respectively corresponding to the first sub regions and detecting second feature points according to the first threshold values respectively corresponding to the second sub regions, matching each of the first feature points with each of the second feature points, finding point correspondences in the matched feature points, and providing the point correspondences to an image processing device.

### CROSS-REFERENCE TO RELATED APPLICATION

This application claims priority under 35 U.S.C. §119(a) to Korean Patent Application No. 10-2012-0051697 filed on May 15, 2012, the disclosure of which is hereby incorporated by reference in its entirety.

### BACKGROUND

1. Technical Field

Embodiments of the inventive concept relate to a three-dimensional (3D) display technique, and more particularly, to a method, device and system for finding point correspondences between stereo images.

2. Discussion of Related Art

A 3D display technique relates to providing 3D images to a viewer using a 3D display device. For instance, the 3D display technique may be stereoscopics. Stereoscopics is a technique for creating or enhancing the illusion of depth in an image by presenting two offset images separately to the left and right eye of the viewer.

The 3D display technique extracts feature points from stereo images and matches the extracted feature points between the stereo images. However, when there is a lack of texture or color information, it may be difficult to extract the feature points from the stereo images and match them between the stereo images.

### SUMMARY

According to an exemplary embodiment of the inventive concept, a method of finding point correspondences includes dividing a first left image into first sub regions and a first right image into second sub regions, detecting first feature points according to first threshold values respectively corresponding to the first sub regions and detecting second feature points according to the first threshold values respectively corresponding to the second sub regions, matching each of the first feature points with each of the second feature points, finding point correspondences in the matched feature points, and providing the point correspondences to an image processing device.

The finding of the point correspondences may include comparing a first feature vector of each of the first feature points with a second feature vector of each of the second feature points and finding the point correspondences in the matched feature points according to a comparison result and a second threshold value.

The method may further include updating the first threshold values according to the feature points detected in the first left image or the first right image. The method may further include detecting feature points in a second left image and a second right image according to the first updated threshold values. The method may further include updating the second threshold value according to the point correspondences.

The method may further include detecting feature points in a second left image and a second right image respectively, and matching the feature points between the second left image and the second right image and finding point correspondences in the matched feature points according to the second updated threshold value.

The method may further include estimating depth information in the first left image and the first right image using the point correspondences. The method may further include calculating a fundamental matrix using the point correspondences. The first threshold values may be different from each other.

According to an exemplary embodiment of the inventive concept, a processor includes a feature point detection block and a feature point comparator. The feature point detection block is configured to divide each of a pair of stereo images into sub regions and to detect feature points in a left image and a right image among the pair of stereo images according to first threshold values respectively corresponding to the sub regions. The feature point comparator is configured to match the feature points between the left and right images and to find point correspondences in the matched feature points according to a second threshold value. The processor may be configured to update the first threshold values according to the detected feature points. The processor may be configured to update the second threshold value according to the point correspondences.

The processor may further include a fundamental matrix calculator configured to calculate a fundamental matrix using the point correspondences.

According to an exemplary embodiment of the inventive concept, a stereo imaging system includes image sensors configured to respectively receive a pair of stereo images and the above-described processor. The stereo imaging system may be a three-dimensional (3D) display device.

According to an exemplary embodiment of the invention concept, a stereo image generation system includes a first image sensor configured to generate a left image of a pair of stereo images, a second image sensor configured to generate a right image of the pair, and a processor. The processor is configured to: define first sub regions within the left image and second sub regions within the right image, detect first feature points according to first threshold values respectively corresponding to the first sub regions and second feature points according to the first threshold values respectively corresponding to the second sub regions, match each of the first feature points with each of the second feature points, determine point correspondences in the matched feature points, and output the stereo images rectified using the determined point correspondences.

The processor may detect the first feature points by determining second feature points in each of the sub regions and removing the second feature points less than the corresponding first threshold value, where the remaining second feature points correspond to the first detected feature points. The processor may increase one of the first threshold values when the remaining second feature points are less than a desired range. The processor may decrease the one first threshold value when the remaining second feature points are greater than the desired range. The sub regions may be either rectangles or circles. The processor may determine the point correspondences by determining similarities among the matched feature points and removing the match feature points with similarities less than a second threshold, where the remaining matched feature points correspond to the point correspondences.

### BRIEF DESCRIPTION OF THE DRAWINGS

FIG. 1 is a block diagram of a stereo imaging system according to an exemplary embodiment of the inventive concept;

FIG. 2 is a diagram of a plurality of images output from image sensors illustrated in FIG. 1 according to an exemplary embodiment of the inventive concept;

FIG. 3 is a diagram of the plurality of images divided into a plurality of sub regions by a feature point detection block illustrated in FIG. 1 according to an exemplary embodiment of the inventive concept;

FIG. 4 is a diagram of the plurality of images divided into a plurality of sub regions by the feature point detection block illustrated in FIG. 1 according to an exemplary embodiment of the inventive concept;

FIG. 5 is a diagram of the plurality of sub regions of FIG. 3 including feature points detected by the feature point detection block illustrated in FIG. 1 according to an exemplary embodiment of the inventive concept;

FIG. 6 is a diagram of the plurality of sub regions of FIG. 3 including first threshold values according to an exemplary embodiment of the inventive concept;

FIG. 7 is a diagram of the plurality of sub regions including examples of the first threshold values;

FIG. 8 is a diagram of the plurality of sub regions of FIG. 3 including feature points depending on each of the first threshold values illustrated in FIG. 6;

FIG. 9 is a diagram of the plurality of sub regions of FIG. 8 including exemplary feature points matched by a feature point comparator illustrated in FIG. 1;

FIG. 10 is a flowchart of a method of operating a processor illustrated in FIG. 1 according to an exemplary embodiment of the inventive concept; and

FIG. 11 is a flowchart of a method of operating the processor illustrated in FIG. 1 according to an exemplary embodiment of the inventive concept.

### DETAILED DESCRIPTION

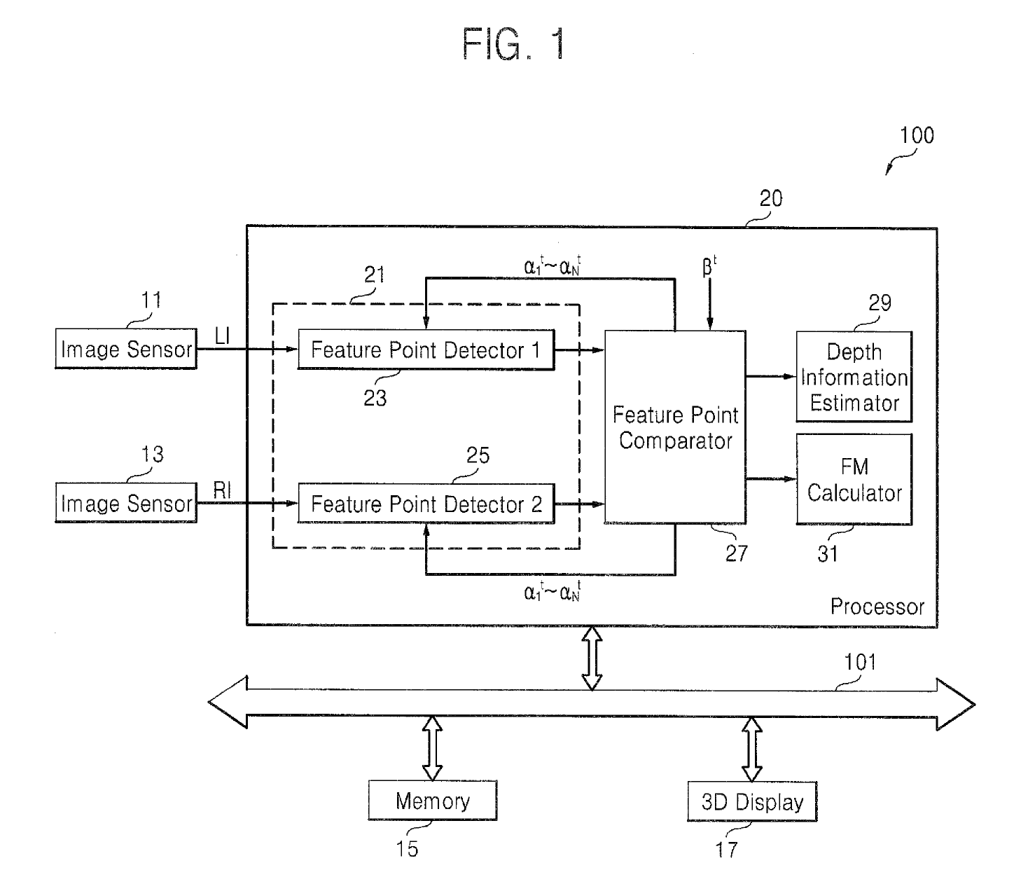

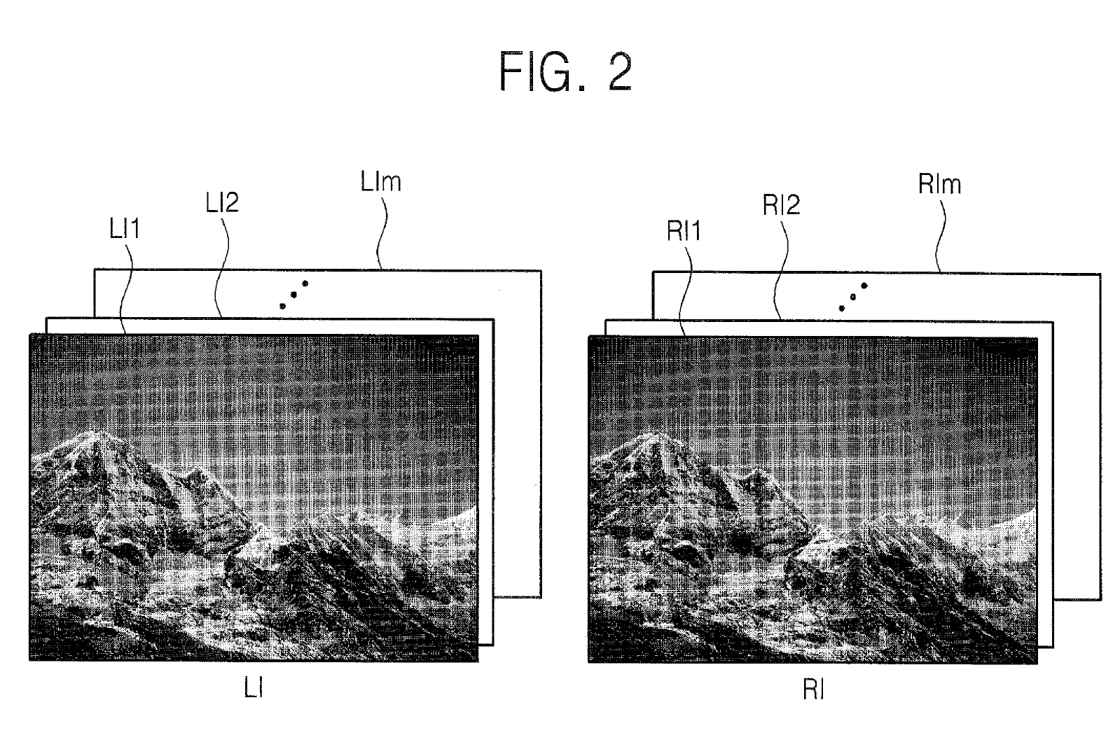

FIG. 1 is a block diagram of a stereo imaging system 100 according to an exemplary embodiment of the inventive concept. FIG. 2 is a diagram of a plurality of left images LI1 through Um and right image RI1 through RIm output from a left image sensor 11 and a right image sensor 13, respectively illustrated in FIG. 1 according to an exemplary embodiment of the inventive concept.

Referring to FIGS. 1 and 2, the stereo imaging system 100 provides a three-dimensional (3D) image to a viewer. The stereo imaging system 100 may be a 3D display device such as a personal computer (PC), a laptop computer, a smart phone, or a tablet PC.

The stereo imaging system 100 includes the left image sensor 11, the right image sensor 13, a processor 20, a memory 15, and a 3D display 17. The elements 15, 17, and 20 communicate with one another through a bus 101.

The image sensors 11 and 13 generate a pair of stereo images LI and RI, respectively. For instance, the left image sensor 11 may generate “m (which is a natural number)” left images LI to be presented to the left eye of the viewer through the 3D display 17. The second image sensor 13 may generate “m” right images RI to be presented to the right eye of the viewer through the 3D display 17. The left images LI include a plurality of the images LI1 through LIm and the right images RI include a plurality of the images RI1 through RIm. The left images LI and right images RI may be referred to as stereo images LI and RI.

A pair of the stereo images LI and RI may be digital signals. While FIG. 1 shows one left image sensor 11 and one right image sensor 13, the number of image sensors may be different according to alternate embodiments. For example, the stereo imaging system 100 could include two or more left image sensors or two or more right image sensors.

The memory 15 may store the pair of the stereo images LI and RI that have been processed by the processor 20. The memory 15 may be implemented by a read only memory (ROM), a programmable ROM (PROM), an erasable PROM (EPROM), an electrically EPROM (EEPROM), a flash memory, a ferroelectric random access memory (FRAM), a magnetic RAM (MRAM), a phase-change RAM (PRAM), a nano RAM (NRAM), silicon-oxide-nitride-oxide-silicon (SONOS), resistive memory, racetrack memory, etc.

The processor 20 receives a pair of the stereo images LI and RI from the left image sensor 11 and the right image sensor 13, respectively, and performs an image processing operation to display the stereo images LI and RI on the 3D display 17. The processor 20 may be referred to as an image signal processor (ISP).

In an exemplary embodiment, the processor 20 includes a feature point detection block 21, a feature point comparator 27, a depth information estimator 29, and a fundamental matrix (FM) calculator 31.

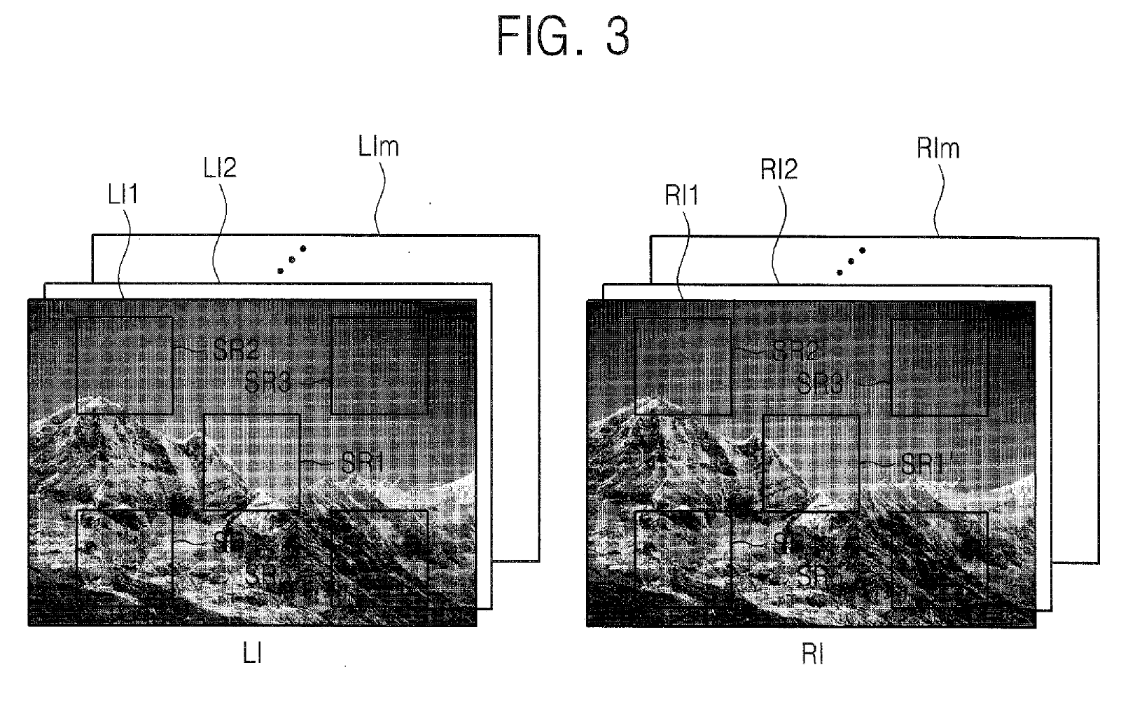

The feature point detection block 21 divides the “m” left images LI and the “m” right images RI into sub regions. For example, several sub regions may be defined within each left image and several sub regions may be defined within each right image. The sub regions of a particular image resulting from the dividing need not be contiguous with one another. For example, space may be present between each sub region as shown in FIG. 3. However, in an exemplary embodiment, the sub regions are contiguous with one another. For example, in this embodiment, the image is divided into sub regions and no space is present between the resulting sub regions. The feature point detection block 21 includes a first feature point detector 23 and a second feature point detector 25. The first feature point detector 23 divides the “m” left images LI into first sub regions. The second feature point detector 25 divides the “m” right images RI into second sub regions.

FIG. 3 is a diagram of a plurality of the left images LI1 through LIm divided into a plurality of sub regions SR1 through SR5 and the right images RI1 through RIm divided into a plurality of sub regions SR1′ through SR5′ by the feature point detection block 21 illustrated in FIG. 1 according to an exemplary embodiment of the inventive concept. Referring to FIGS. 1 through 3, each of the left images LI is divided into the first sub regions SR1 through SR5 by the feature point detection block 21. Each of the right images RI is divided into the second sub regions SR1′ through SR5′ by the feature point detection block 21.

While FIG. 3 shows five rectangular or square shaped sub regions spaced apart from one another at respective positions, the sub regions are not limited to any particular number, shape, or position. In an embodiment of the inventive concept, the number, positions or shapes of the first sub regions SR1 through SR5 is the same as the number, positions or shapes of the second sub regions SR1′ through SR5′. The first sub regions SR1 through SR5 correspond to the second sub regions SR1′ through SR5′, respectively. In an exemplary embodiment of the inventive concept, the number, positions or shapes of the first sub regions SR1 through SR5 is different from the number, positions or shapes of the second sub regions SR1′ through SR5′.

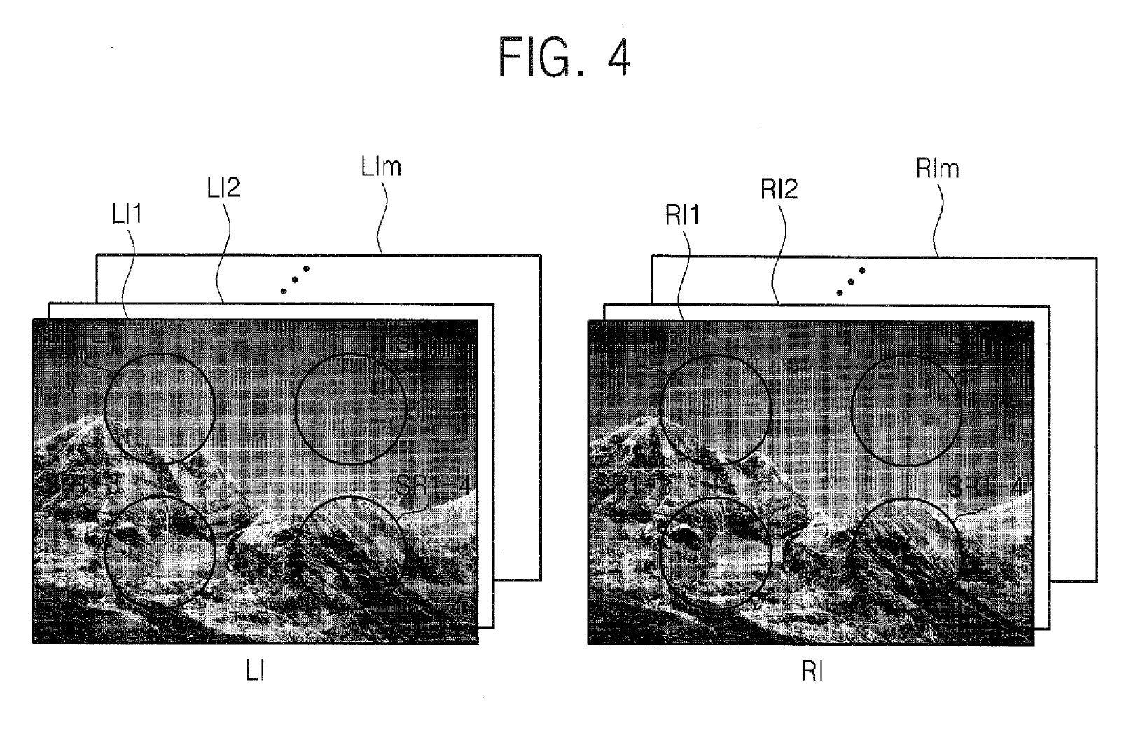

FIG. 4 is a diagram of a plurality of left images LI1 through LIm divided into a plurality of sub region SR1-1 through SR1-4 and a plurality of right images RI1 through RIm divided into a plurality of sub regions SR1-1′ through SR1-4′ by the feature point detection block 21 illustrated in FIG. 1 according to an exemplary embodiment of the inventive concept. For example, as shown in FIG. 4, four circular or elliptical shaped sub regions are spaced apart from one another in each image at respective positions. However, as discussed above, the number, shape, and position of the sub regions may vary in alternate embodiments.

Referring to FIGS. 1, 2, and 4, each of the left images LI is divided into the sub regions SR1-1 through SR1-4 by the feature point detection block 21. Each of the right images RI is divided into the sub regions SR1-1′ through SR1-4′ by the feature point detection block 21. As described above, the sub regions SR1-1 through SR1-4 correspond to the sub regions SR1-1′ through SR1-4′, respectively.

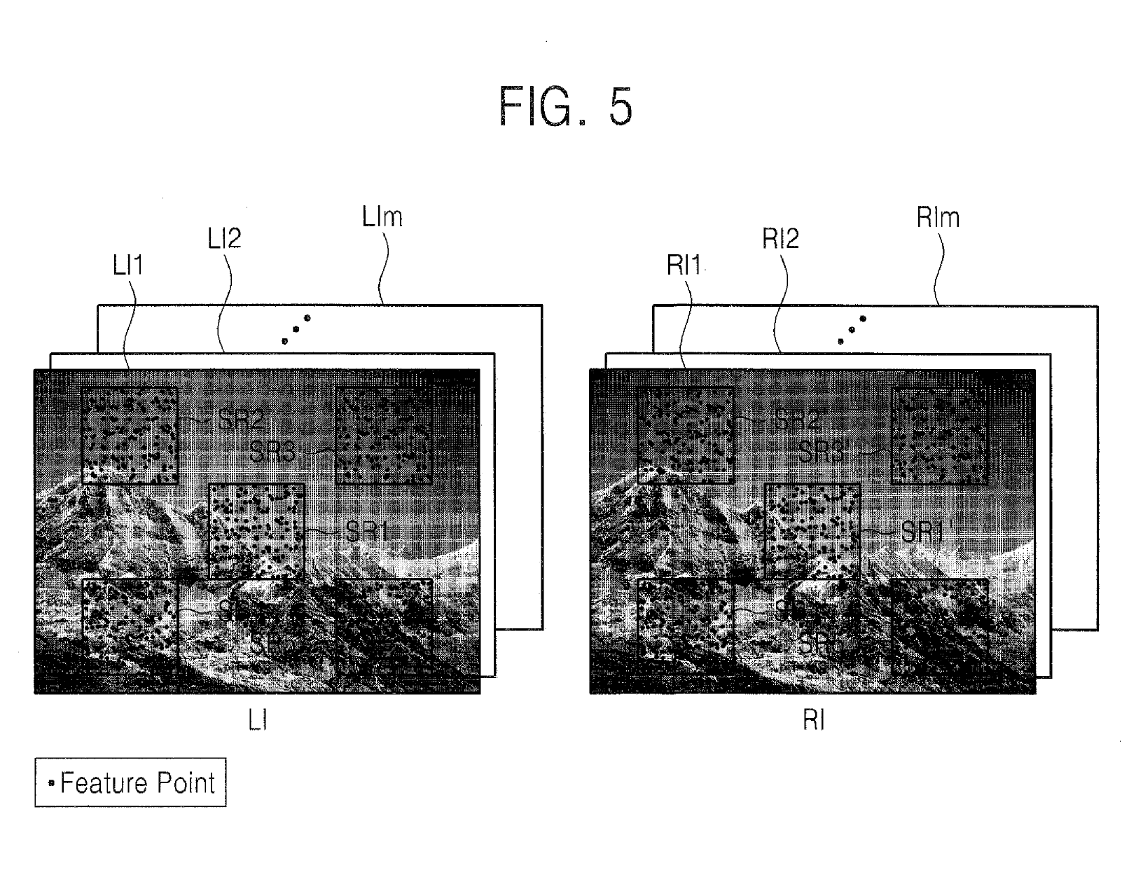

FIG. 5 is a diagram of the plurality of left images LI1 through LIm and right images RI1 through RIm including feature points detected by the feature point detection block 21 illustrated in FIG. 1 according to an exemplary embodiment of the inventive concept. Referring to FIGS. 1 through 3 and FIG. 5, the feature point detection block 21 may detect a plurality of feature points from each of the first left image LI1 and the first right image RI1 in a pair.

The first feature point detector 23 may detect a plurality of feature points from the first left image LI1. The second feature point detector 25 may detect a plurality of feature points from the first right image RI1. The feature points are interesting parts in the pair of the images LI and RI for image processing. For instance, the feature points may be detected using an algorithm such as a scale invariant feature transform (SIFT) or speeded up robust feature (SURF).

The feature point detection block 21 may be designed to realize the algorithm, e.g., SIFT or SURF. Alternatively, a feature region instead of a feature point may be detected. For instance, the feature region may be an edge, a corner, a curve (e.g., open or closed), etc.

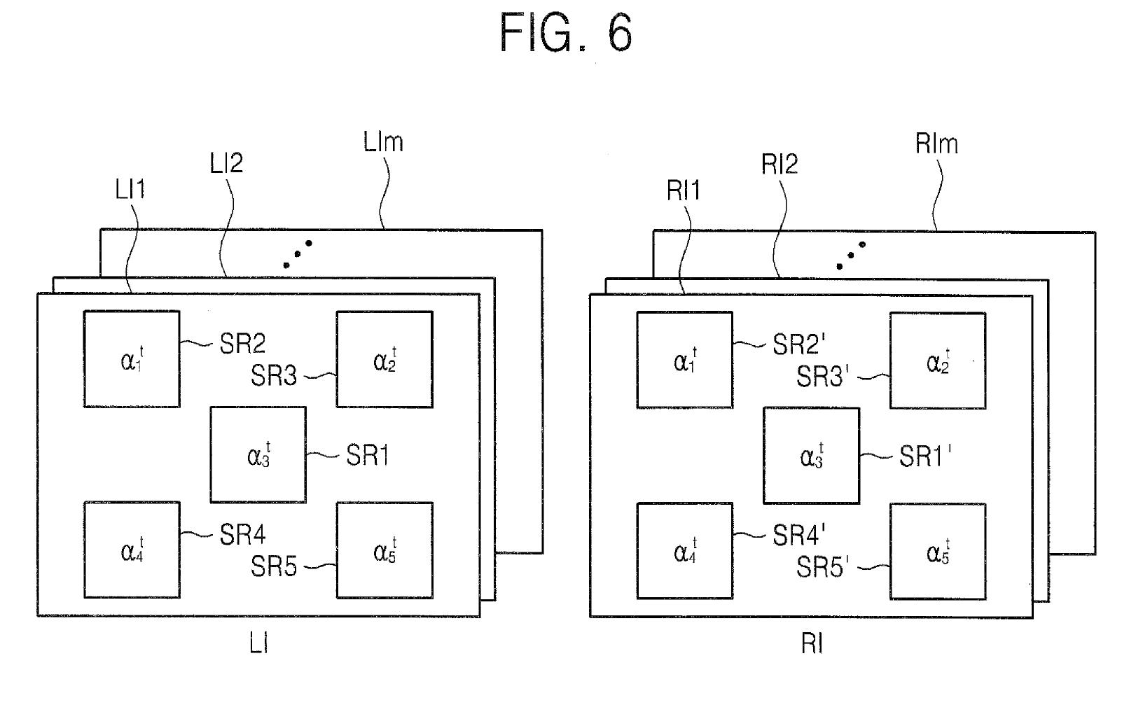

FIG. 6 is a diagram of a plurality of the left images LI1 through LIm and right images RI1 through RIm including first threshold values α₁^{t} through Ε_{N}^{t} corresponding to the respective sub regions SR1 through SR5 and the respective sub regions SR1′ through SR5′ illustrated in FIG. 3 according to an exemplary embodiment of the inventive concept. For sake of convenience in the description, only the sub regions SR1 through SR5 and SR1′ through SR5′ and the first threshold values α₁^{t} through α_{N}^{t} are illustrated in FIG. 6. In this example, N is 5. Referring to FIGS. 1, 5, and 6, the first sub regions SR1 through SR5 include the first threshold values α₁^{t} through α_{N}^{t}, respectively. The second sub regions SR1′ through SR5′ include the first threshold values α₁^{t} through α_{N}^{t}, respectively.

In an exemplary embodiment, the first threshold values α₁^{t} through α_{N}^{t} respectively corresponding to the first sub regions SR1 through SR5 is the same as the first threshold values α₁^{t} through α_{N}^{t} respectively corresponding to the second sub regions SR1′ through SR5′. In an exemplary embodiment, the first threshold values α₁^{t} through α_{N}^{t} respectively corresponding to the first sub regions SR1 through SR5 differ from the first threshold values α₁^{t} through α_{N}^{t} respectively corresponding to the second sub regions SR1′ through SR5′. In a first threshold value αₖ^{t}, the subscript “k” denotes a position of a sub region in a sequence and the superscript “t” denotes a position of an image in a sequence. For instance, α₂¹ denotes a threshold value of the second sub region in the first left image or the first right image.

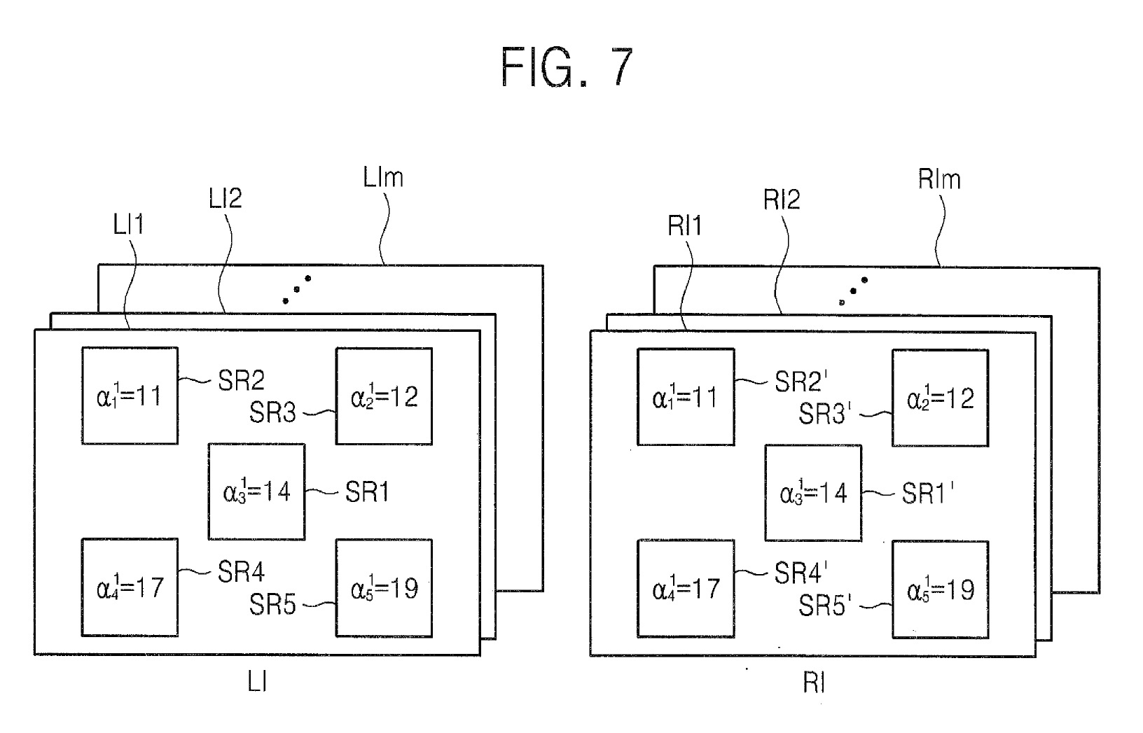

FIG. 7 is a diagram of a plurality of the left images LI1 through LIm and right image RI1 through RIm including examples of the first threshold values α₁^{t} through α_{N}^{t} corresponding to the respective sub regions SR1 through SR5 and the respective sub regions SR1′ through SR5′ illustrated in FIG. 3. For sake of convenience in the description, only the sub regions SR1 through SR5 and SR1′ through SR5′ and the first threshold values α₁^{t} through α_{N}^{t} are illustrated in FIG. 7.

Referring to FIG. 1 and FIGS. 5 through 7, the first threshold values α₁^{t} through α_{N}^{t} may be different from one another depending on the first sub regions SR1 through SR5. Alternatively, the first threshold values α₁^{t} through α_{N}^{t} may be different from one another depending on the second sub regions SR1′ through SR5′.

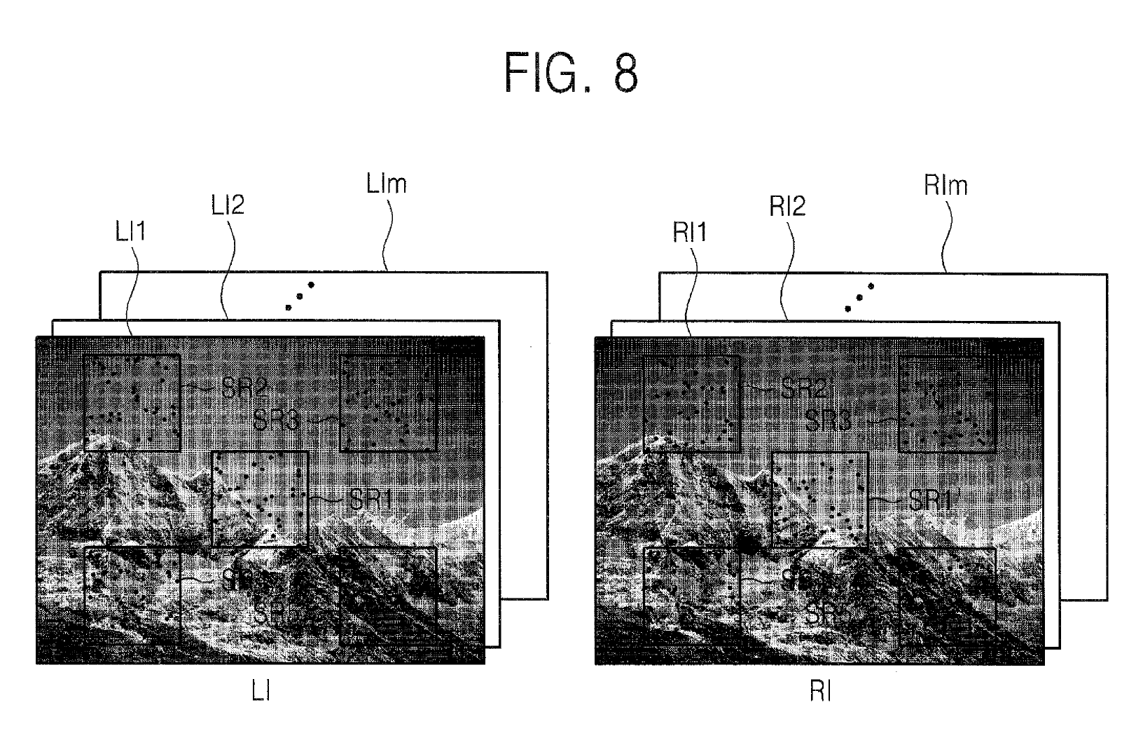

FIG. 8 is a diagram of a plurality of the left images LI1 through LIm and right images RI1 through RIm including feature points depending on each of the first threshold values α₁^{t} through α_{N}^{t} illustrated in FIG. 6. Referring to FIG. 1 and FIGS. 5 through 8, the feature point detection block 21 removes poor feature points from the feature points detected from each of the first left image LI1 and the first right image RI1 according to the first threshold values α₁^{t} through α_{N}^{t}.

For instance, feature points having a value less than the threshold value α₁¹ are removed from the feature points detected from the sub regions SR1 and SR1′. Similarly, feature points having a value less than the threshold value α₃¹ are removed from the feature points detected from the sub regions SR3 and SR3′. In an exemplary embodiment, a threshold value corresponds to intensity. For example, feature points with intensity below the threshold value would be removed. If a point is representative of color, the threshold could correspond to the highest intensity red, green, and blue component of that color, or an average intensity of the red, green, and blue components. A threshold value may correspond to a percentage of intensity or an amount of intensity value out of a maximum intensity. For example, the threshold value α₃¹ of 14 could be a 14% intensity that is less than 100% full intensity or 14 out of a maximum intensity of 255, etc.

In this manner, feature points having a value less than each of the first threshold values α₁^{t} through α_{N}^{t} are removed from the feature points detected from a corresponding one of the first sub regions SR1 through SR5 and a corresponding one of the second sub regions SR1′ through SR5′. In an exemplary embodiment, the value of each feature point is a value of a second order Taylor expansion in the SIFT algorithm. In this embodiment, the threshold values may be threshold values that are offset from a value of a second order Taylor expansion to indicate a weak feature point.

The first threshold values α₁^{t} through α_{N}^{t} are updated according to the number of feature points left in each of the first left images LI1 and the right images RI1. For instance, it is assumed that the first threshold values α₁^{t} through α_{N}^{t} (where N is 5) corresponding to the respective sub regions SR1 through SR5 in the left image LI1 and the respective sub regions SR1′ through SR5′ in the right image RI1 are 14, 12, 12, 17, and 19, respectively, and the number of feature points in each of the sub regions SR1 through SR5 ranges from 10 to 20. The above threshold values and feature point range are merely used as examples, as the threshold values and feature point range may vary.

A threshold value could either be increased or decreased based on the number of feature points left in a particular image. For example, if a first threshold value α₁^{t} of 11 caused removal of several feature points, the removal process could be re-run with an updated first threshold value α₁^{t} of 14 to remove additional points from the same image, or the updated threshold value could be applied to a sub region of a subsequent image for use in removing its feature points. In another example, if a first threshold value α₃^{t} of 14 caused removal of 0 or very few feature points, the removal process could be re-run with an updated first threshold value α₃^{t} of 12 in an attempt to find some or additional feature points to remove, or the updated threshold value could be applied to a sub region of a subsequent image for use in removing its feature points.

In one example where 7 feature points are detected in the first sub region SR1 of the first image LI1 according to the first threshold value α₁^{t}, the first threshold value α₁^{t} is updated to be less than 14. In another example, where 22 feature points are detected in the sub region SR2 of the first image LI1 according to the first threshold value α₁^{t}, the first threshold value α₂^{t} is updated to be greater than 12. As discussed above, first updated threshold values α₁^{t+1} through α_{N}^{t+1} may be used to detect feature points in subsequent stereo images.

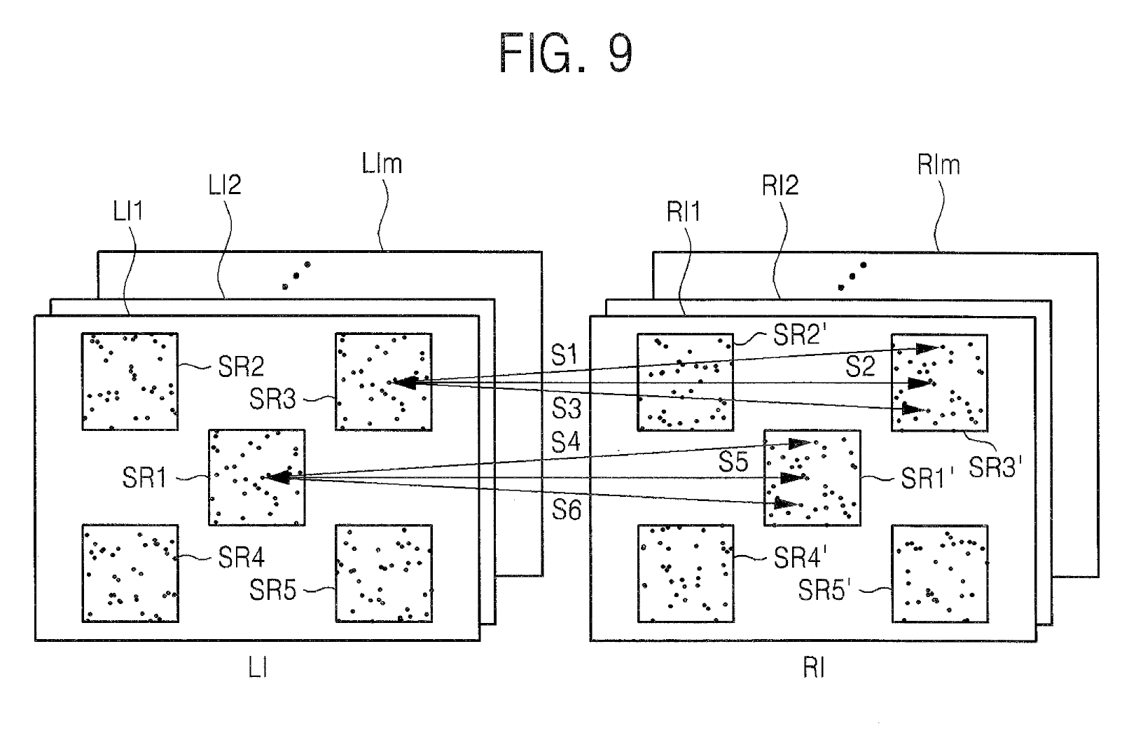

FIG. 9 is a diagram of a plurality of the left images LI1 through LIm and right images RI1 through RIm including feature points matched by the feature point comparator 27 illustrated in FIG. 1. For sake of convenience in the description, only the sub regions SR1 through SR5 and SR1′ through SR5′ and the feature points are illustrated in FIG. 9. Referring to FIG. 1 and FIGS. 5 through 9, a feature vector is generated from each of the feature points when the feature points are detected by the feature point detection block 21 in each of the first left and right images LI1 and RI1. The left and right images may be offset from one another and provided to a viewer to give the perception of 3D depth. The feature vector may be referred to as a feature descriptor. In an exemplary embodiment, the feature vector is expressed as a list of intensities. In an exemplary embodiment, the feature vector is expressed as a list of colors or textures. In an exemplary embodiment, the feature vector is expressed as a histogram.

The feature point comparator 27 matches feature vectors between the left and right images LI1 and RI1. The feature point comparator 27 compares a feature vector of a feature point in the left image LI1 with feature vectors of feature points in the right image RI1 and calculates similarities (e.g., S1, S2, and S3) from the comparison result. The similarities S1, S2, and S3 may be calculated using a mean square error. For instance, the feature point comparator 27 matches a feature vector of a feature point detected in the sub region SR3 in the left image LI1 with a feature vector of a feature point having the greatest similarity (e.g., S2) among the similarities S1, S2, and S3 in the second sub region SR3′ in the right image RI1.

The feature point comparator 27 matches a feature vector of a feature point detected in the sub region SR1 in the left image LI1 with a feature vector of a feature point having the greatest similarity (e.g., S5) among similarities S4, S5, and S6 in the second sub region SR1′ in the right image RI1. The similarities S4, S5, and S6 may be calculated using a mean square error.

The feature point comparator 27 compares each of the greatest similarities (e.g., S2 and S5) with a second threshold value β^{t} to find a point correspondence. For example, even when feature vectors are matched with each other, feature points having the similarity (e.g., S2) less than the second threshold value β^{t} among the greatest similarities (e.g., S2 and S5) are removed by the feature point comparator 27. In the second threshold value β^{t}, the superscript “t” denotes an order of a current image in a sequence of the images LI or RI. Accordingly, the feature point comparator 27 may find point correspondences in the matched feature points. In an exemplary embodiment, the images LI and RI may be output to an image processing device or a display. A pair of the images LI and RI may be offset from one another and presented to a view to give the perception of 3D depth. When the image processing device or display is a 3D display, the found point correspondences may be used by the display to improve the perception of the images LI and RI as 3D images.

The second threshold value β^{t} is updated according to the point correspondences. For instance, when there are too many point correspondences, the second threshold value β^{t} may be updated to have a larger value. When there are too few point correspondences, the second threshold value β^{t} may be updated to have a smaller value. A second updated threshold value β^{t+1} is used to find point correspondences in subsequent stereo images. Referring to FIG. 1, the depth information estimator 29 estimates depth information (e.g., sparse depth information) from stereo images using point correspondences. In an exemplary embodiment, the images LI and RI may be presented on a display using the depth information. For example, when the display is a 3D display, the depth information may be used by the display to improve the perception of the images LI and RI as 3D images. In an exemplary embodiment, the depth information indicates a distance from a camera to one or more objects within each of the images.

The FM calculator 31 calculates an FM using the point correspondences. The FM is used to explain the geometric relationship between point correspondences in a pair of uncorrected stereo images respectively output from the left image sensor 11 and the right image sensor 13. In an exemplary embodiment, the images LI and RI may be presented on a display using the FM. For example, when the display is a 3D display, the display may use the FM to improve the perception of the images LI and RI as 3D images. For example, the display may perform image rectification on the images LI and RI using the FM. The image rectification may project a pair of the images LI and RI onto a common plane. The image rectification may correct image distortion.

While FIG. 1 shows the processor 20 including both a depth information estimator 29 and an FM calculator 31, in alternate embodiment of the processor, one of the estimator 29 and the calculator 31 may be omitted.

In an exemplary embodiment, the found point correspondences are used to generate an auto-convergence tool within a 3D display. For example, one of a pair images LI and RI may be shifted in a horizontal direction a certain distance relative to the other image of the pair based on the found point correspondences to reduce a vergence-accommodation conflict.

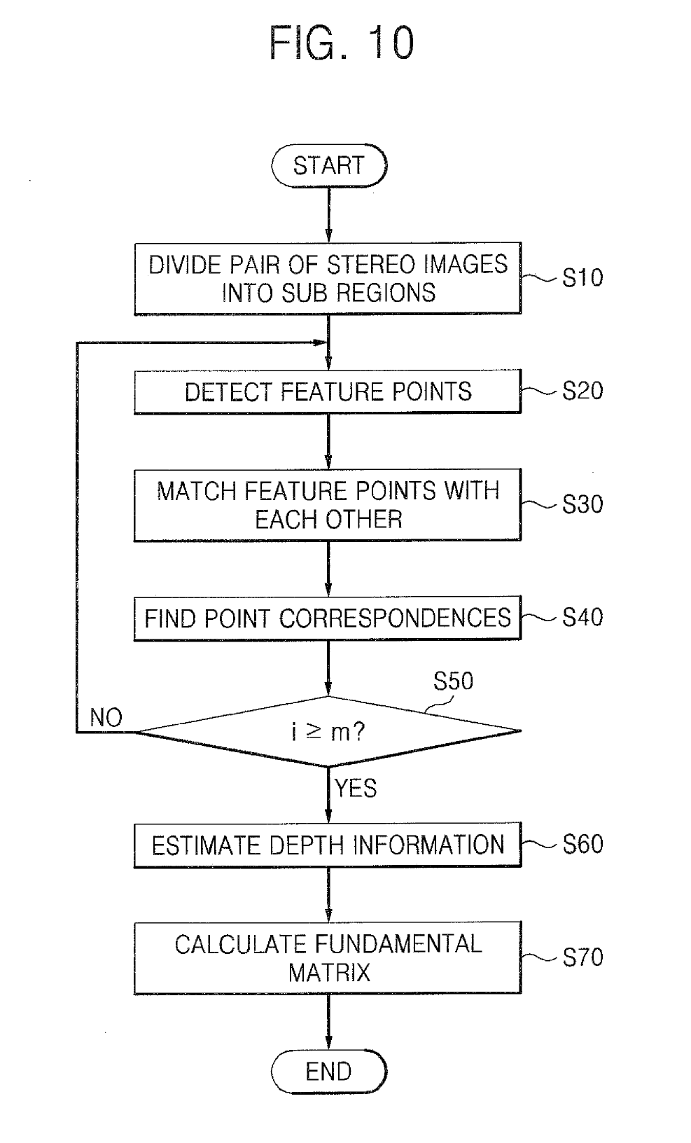

FIG. 10 is a flowchart of a method of operating the processor 20 illustrated in FIG. 1 according to an exemplary embodiment of the inventive concept. Referring to FIGS. 1 through 10, the feature point detection block 21 divides each of the left images LI into the first sub regions SR1 through SR5 and divides each of the right images RI into the second sub regions SR1′ through SR5′ (S10).

The first feature point detector 23 divides each of the left images LI into the first sub regions SR1 through SR5. The second feature point detector 25 divides each of the right images RI into the second sub regions SR1′ through SR5′.

The feature point detection block 21 detects feature points in an i-th left image (e.g., LI1) among the left images LI according to the first threshold values α₁^{t} through α_{N}^{t} respectively corresponding to the sub regions SR1 through SR5 and detects feature points in an i-th right image (e.g., RI1) among the right images RI according to the first threshold values α₁^{t} through α_{N}^{t} respectively corresponding to the sub regions SR1′ through SR5′ (S20). The first threshold values α₁^{t} through α_{N}^{t} respectively correspond to the first sub regions SR1 through SR5. The first threshold values α₁^{t} through α_{N}^{t} may be different from each another.

The first feature point detector 23 detects feature points in the i-th left image (e.g., LI1) and removes feature points having values less than the first threshold values α₁^{t} through α_{N}^{t}. The second feature point detector 25 detects feature points in the i-th right image (e.g., RI1) and removes feature points having values less than the first threshold values α₁^{t} through α_{N}^{t}.

The first threshold values α₁^{t} through α_{N}^{t} are updated according to the number of the remaining feature points. The first updated threshold values α₁^{t+1} through α_{N}^{t+1} are used to detect feature points in (i+1)-th stereo images. For example, the threshold values may be increased or decreased depending on whether too many or too little feature points have been removed. For example, if a range of feature points is considered desirable, and a threshold value resulted in a number of feature points outside the range, then the threshold value could be increased or decreased for subsequent stereo images to ensure that the number of removed feature points leaves a remaining number of feature points within the desired range.

The feature point comparator 27 matches the feature points between the i-th images (e.g., LI1 and RI1) (S30). The feature point comparator 27 compares feature vectors between the images LI1 and R11 and calculates similarities (e.g., S1, S2, and S3) from the comparison result. The feature point comparator 27 matches a feature vector in the left image LI1 with a feature vector having the greatest similarity (e.g., S2) in the right image RI1. The feature point comparator 27 finds point correspondences in the matched feature points based on the second threshold value β^{t} (S40).

The feature point comparator 27 compares each of the greatest similarities (e.g., S2 and S5) with the second threshold value β^{t} to find the point correspondences. Even when feature vectors are matched with each other, feature points having the similarity (e.g., S2) less than the second threshold value β^{t} among the greatest similarities (e.g., S2 and S5) are removed. In other words, the feature point comparator 27 finds the point correspondences.

The second threshold value ⊖^{t} is updated according to the point correspondences. The second updated threshold value β^{t+1} is used to find point correspondences in the (i+1)-th stereo images. The detection operation and the matching operation are repeated up to m-th stereo images LIm and RIm (S50). The depth information estimator 29 estimates depth information from the stereo images LI and RI using the point correspondences (S60). The FM calculator 31 calculates an FM using the point correspondences (S70).

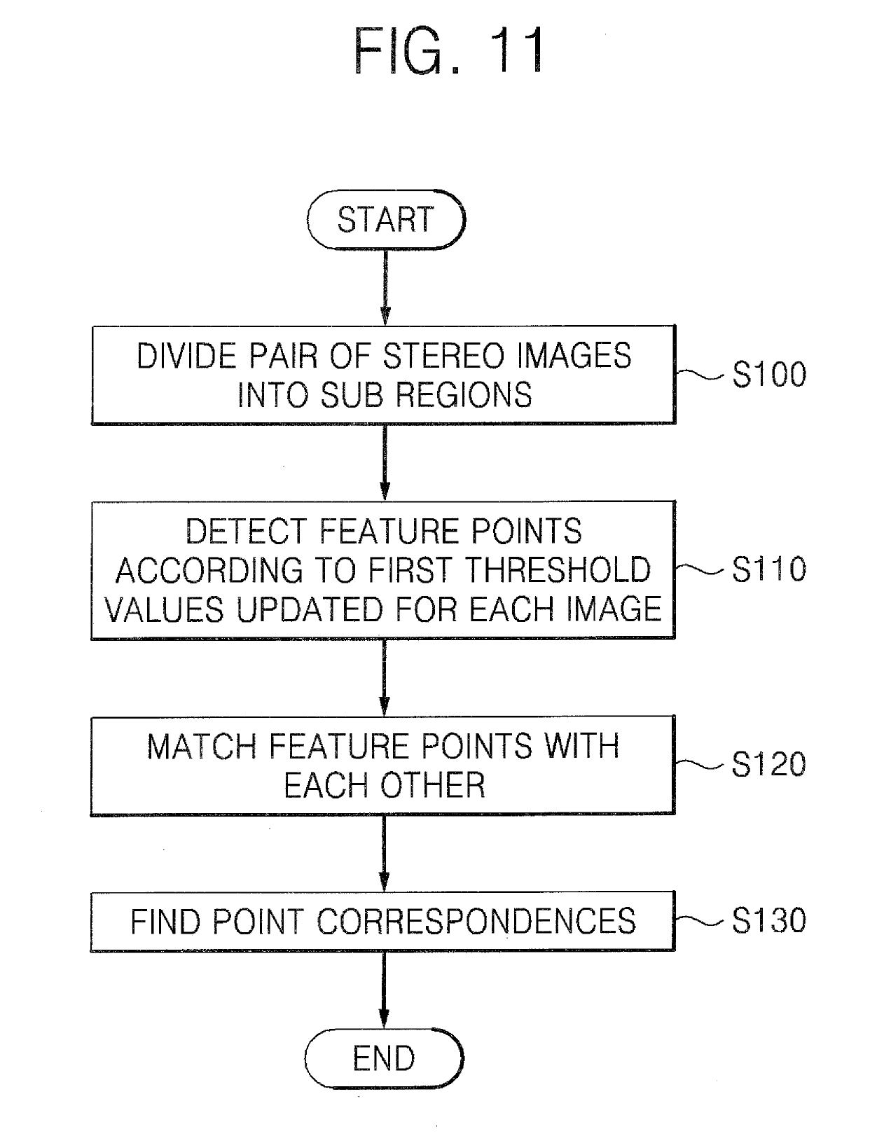

FIG. 11 is a flowchart of a method of operating the processor 20 illustrated in FIG. 1 according to an exemplary embodiment of the inventive concept. Referring to FIGS. 1 through 9 and FIG. 11, the feature point detection block 21 divides each of the left images LI into the first sub regions SR1 through SR5 and divides each of the right images RI into the second sub regions SR1′ through SR5′ (S100).

The feature point detection block 21 detects feature points according to the first threshold values α₁^{t} through α_{N}^{t} updated for each of the images LI and RI (S110). The feature point comparator 27 matches feature points between the images LI and RI in (S120). The feature point comparator 27 finds point correspondences in the matched feature points according to the second threshold value β^{t} updated for each of the images LI and RI (S130). Depth information may be estimated from the stereo images using the point correspondences or an FM may be calculated using the point correspondences.

As described above, according to at least one embodiment of the inventive concept, threshold values used to detect and match feature points between a pair of stereo images are adaptively updated, so that point correspondences may be found more robustly.

While the inventive concept has been particularly shown and described with reference to exemplary embodiments thereof, it will be understood by those of ordinary skill in the art that various changes in forms and details may be made therein without departing from the spirit and scope of the inventive concept.

What is claimed is:

1. A method of finding point correspondences, the method comprising:
dividing a first left image into first sub regions and a first right image into second sub regions;
detecting first feature points according to first threshold values respectively corresponding to the first sub regions and detecting second feature points according to the first threshold values respectively corresponding to the second sub regions;
matching each of the first feature points with each of the second feature points;
finding point correspondences in the matched feature points; and
providing the point correspondences to an image processing device.

2. The method of claim 1, wherein the finding the point correspondences comprises:
comparing a first feature vector of each of the first feature points with a second feature vector of each of the second feature points; and
finding the point correspondences in the matched feature points according to a comparison result and a second threshold value.

3. The method of claim 1, further comprising updating the first threshold values according to the feature points detected in the first left image or the first right image.

4. The method of claim 3, further comprising detecting feature points in a second left image and a second right image according to the first updated threshold values.

5. The method of claim 2, further comprising updating the second threshold value according to the point correspondences.

6. The method of claim 5, further comprising:
detecting feature points in a second left image and a second right image respectively; and
matching the feature points between the second left image and the second right image and finding point correspondences in the matched feature points according to the second updated threshold value.

7. The method of claim 1, further comprising estimating depth information in the first left image and the first right image using the point correspondences.

8. The method of claim 1, further comprising calculating a fundamental matrix using the point correspondences.

9. The method of claim 1, wherein the first threshold values are different from each other.

10. A processor comprising:
a feature point detection block configured to divide each of a pair of stereo images into sub regions and to detect feature points in a left image and a right image among the pair of stereo images according to first threshold values respectively corresponding to the sub regions; and
a feature point comparator configured to match the feature points between the left and right images and to find point correspondences in the matched feature points according to a second threshold value.

11. The processor of claim 10, wherein the processor is configured to update the first threshold values according to the detected feature points.

12. The processor of claim 10, wherein the processor is configured to update the second threshold value according to the point correspondences.

13. The processor of claim 10, further comprising a fundamental matrix calculator configured to calculate a fundamental matrix using the point correspondences.

14. A stereo imaging system comprising:
image sensors configured to respectively receive the pair of stereo images; and
the processor of claim 10.

15. The stereo imaging system of claim 14, wherein the stereo imaging system is a three-dimensional (3D) display device.

16. A stereo image generation system comprising:
a first image sensor configured to generate a left image of a pair of stereo images;
a second image sensor configured to generate a right image of the pair; and
a processor configured to:
define first sub regions within the left image and second sub regions within the right image,
detect first feature points according to first threshold values respectively corresponding to the first sub regions and second feature points according to the first threshold values respectively corresponding to the second sub regions,
match each of the first feature points with each of the second feature points,
determine point correspondences in the matched feature points, and
output the stereo images rectified based on the determined point correspondences.

17. The stereo image generation system of claim 16, wherein the processor detects the first feature points by determining second feature points in each of the sub regions and removing the second feature points less than the corresponding first threshold value, wherein the remaining second feature points correspond to the first detected

18. The stereo image generation system of claim 17, wherein the processor increases one of the first threshold values when the remaining second feature points are less than a desired range and decreases the one first threshold value when the remaining second feature points are greater than the desired range.

19. The stereo image generation system of claim 16, wherein the sub regions are either rectangles or circles.

20. The stereo image generation system of claim 16, wherein the processor determines the point correspondences by determining similarities among the matched feature points and removing the match feature points with similarities less than a second threshold, wherein the remaining matched feature points correspond to the point correspondences.
